(19) United States
(12) Patent Application Publication
(10) Pub. No.: US 2021/0041525 A1
(43) Pub. Date: Feb. 11, 2021

(54) Similarity Metric Customized to Radio Measurement in Heterogeneous Wireless Networks and Use Thereof

(71) Applicant: Telefonaktiebolaget LM Ericsson (publ), Stockholm (SE)

(72) Inventor: László Hévizi, Piliscsaba (HU)

(21) Appl. No.: 16/964,032

(22) PCT Filed: Feb. 16, 2018
(86) PCT No.: PCT/EP2018/053901

§ 371 Date: Jul. 22, 2020

(51) Int. Cl. G01S 5/02; G06N 20/00

(52) U.S. Cl. CPC G01S 5/02528; G06N 20/00; G01S 5/02525

(57) ABSTRACT

The present invention relates to a similarity metric customized to radio measurement in heterogeneous wireless networks and to the use of the similarity metric. Radio measurement values reflecting radio access conditions during different measurement time intervals for at least one mobile terminal having radio access to the heterogeneous multi-carrier network are aggregated into radio measurement scans. Further, for every radio measurement scan related radio measurement configurations prevailing at the time of measurement of the corresponding radio measurement values are aggregated into a radio measurement configuration scan. Then the similarity metric is calculated for a pair of radio measurement scans to generate knowledge on radio coverage in the heterogeneous wireless network in a customized manner through reference to radio measurement configuration scans associated with the pair of radio measurement scans for which similarity metrics is to be calculated.

### FIELD OF INVENTION

The present invention related to the processing of measurement data delivered from a heterogeneous wireless network, and in particular to a similarity metric customized to radio measurement conditions in the heterogeneous network and use thereof.

### BACKGROUND ART

Generally, electromagnetic propagation-based localization solutions in cellular wireless communications networks require precise synchronization among radio nodes, as well as, sophisticated and fast reporting from mobile terminals.

Here, the reports from the mobile terminals include received signal strength RSS and time delay measurements, which might be augmented with direction of arrival measurements from the base stations depending on the capabilities of the radio access technology RAT in use. Mobile terminal positions can be centrally tracked via detailed geometric computations often involving 3D radio wave propagation models, yet the positioning accuracy still not satisfactory in many cases.

That is why machine intelligence-based data processing techniques emerge as an alternative method for position estimation. Handling and processing a great volume of measurement data is getting easier nowadays, moreover, the machine intelligence-based techniques do not require detailed parametric models of radio access technologies RAT and propagation.

In more detail, radio location fingerprinting is a machine intelligence technique which determines the location of terminals from the radio signal strength RSS measurements that mobile terminals take on the signals received from neighboring base stations. Recently this technique has been under tests for indoor positioning and for localization where global positioning system GPS is not an option. Indoor positioning by radio location fingerprinting, e.g., which is based on scanning wireless local area network LAN beacon signals is one such known technique.

However, operators of heterogeneous wireless networks may not have all the detailed physical-layer measurements from all radio access technologies RAT at a common central management center, but concentrating inter-RAT RSS measurements might be less difficult. Therefore, a fingerprinting system that is built on the radio signal strength RSS measurements is feasible today.

Further problems occur when a network operator wants to optimize the radio access of mobile terminals over certain RAT-, carrier- and beam combinations even if the mobile terminals do not monitor all of those and have only partial observations on their radio environment. The scan of the radio environment can be partial either because the mobile terminal does not monitor all channels or the network is not transmitting continuously on a channel, e.g. not transmitting on the beam pointing exactly towards the terminal.

Here, machine intelligence techniques are envisaged where network management jointly coordinates the radio resources in multi-RAT, multi-carrier, multi-beam cellular networks and mobile terminals periodically scan and report their radio environment. Then network management can obtain a detailed view of network coverage by machine intelligence techniques. Either unsupervised or supervised machine intelligence techniques are employed in radio signal strength RSS processing both kinds need metrics to compare one field scan of radio signal strength RSS measurements to another.

However, machine intelligence-based radio location fingerprinting, either with supervised or unsupervised learning commonly applies interdisciplinary similarity metrics from the aspect of radio fingerprinting, yet none of the overviewed metrics exploit the peculiarities of radio networks. The input to most metrics is a vector pair of real numbers, each could well be a series of RSS values measured from some known radio sources, i.e. RAT/carrier/cell/beam combinations. The output of these metrics is typically a real number within a defined value set, which represents the similarity/distance of two real-valued vectors of possibly different sizes. The metric formulae treat the vector values equally, despite that the information content of those values might be significantly different.

For example, if a terminal detects signals from a low-power cell or narrow antenna beam in a heterogeneous network, then its position can be well encircled to the coverage area of the transmitter/beam regardless to the measured RSS. On the other hand, the visibility of large macro cells carries less information. This fact should be reflected in the similarity metric. Detecting the same small cell in two different RSS field scans (e.g. when comparing one RSS scan to a scan by another terminal at another time and possibly taken elsewhere) means more similarity between the two scans than detecting the same macro cell even with close RSS values.

Here, a specific problem is comparability of different radio signal strength RSS scans. Machine intelligence techniques need to employ a metric of similarity or equivalently a metric of distance between two RSS fingerprints. Mobile terminals periodically report radio signal strength RSS measurements of the radio access technology RAT/carrier/cell/beam combinations they see and the reporting can be event based, i.e. the mobile terminal sends a radio signal strength RSS measurement report only when an observed signal significantly changes. Significant change typically is when the radio signal strength RSS crosses a threshold and stays there longer than a predefined time period.

Further, a radio signal strength RSS fingerprint is a scan of RSS measurements of recently seen radio access technology RAT/carrier/cell/beam combinations and it can be represented by a vector of real values, where each element corresponds to one of the seen radio access technology RAT/carrier/cell/beam combinations, e.g. an reference symbol received power RSRP value of −93 dBm reported by a mobile terminal measuring an LTE cell at 2.6 GHz. The same mobile terminal may concurrently measure radio signal strength RSS wireless LAN beacons at −60 dBm and −78 dBm at Channel 3 (2.4 GHz band) and Channel 38 (5 GHz band), respectively.

However, while the listed real values are on an absolute power scale, yet the received power measurements of different radio access technologies RATs, carrier frequencies cannot be directly compared.

Moreover, measurements on the same signals, at the same location, but by different mobile terminals cannot be compared either, since the receivers for different radio access technology RAT and carrier combinations are different among vendors and terminal types.

Further, also the receiver and directional antenna gains are factors in the measurements, especially that the latter one also depends on the orientation of the mobile terminal. Beyond the dependence on terminal make and type, real radio signal strength RSS measurements exhibit spatial and temporal variabilities, e.g. fading due to body shadowing, terminal rotation, even if the mobile terminal barely moves.

Further, receiving weak signals usually mean large distance to the transmitter which often goes together with non-LOS line of sight wave propagation. Position estimation with trilateration may work in case of line of sight LOS even if some form of machine learning technique is applied, but in case of diffracted and reflected signals positioning accuracy deteriorates due to the many random factors influencing the propagation.

Yet another restriction is that radio fingerprinting so far is mainly studied for indoor positioning in the context of sensor and wireless local area LAN networks. Most studies assume only one generic radio receiver even if the receivers may differ in the various measurement devices, so that readings of absolute radio signal strength RSS values measured by different devices are still directly compared when the distance or similarity between two RSS scans is computed, see, e.g., Philipp Vorst, Andreas Zell: A Comparison of Similarity Measures for Localization with Passive RFID Fingerprints, ISR/ROBOTIK 2010, ISBN 978-3-8007-3273-9© VDE VERLAG GMBH⋅Berlin⋅Offenbach; Joaqulń Torres-Sospedra, Raúl Montoliu, Sergio Trilles, Óscar Belmonte, Joaqulń Huerta: Comprehensive Analysis of Distance and Similarity Measures for Wi-Fi Fingerprinting Indoor Positioning Systems, Preprint submitted to Elsevier Nov. 23, 2015; and Giuseppe Caso, Luca de Nardis and Maria-Gabriella di Benedetto:A Mixed Approach to Similarity Metric Selection in Affinity Propagation-Based WiFi Fingerprinting Indoor Positioning, Sensors 2015, 15, 27692-27720; doi:10.3390/s151127692.

The studies listed above do not take into account the peculiarities of radio links that may coexist in multi-RAT, multi-carrier heterogeneous networks. Mobile terminals of different makes and models have different gains at the various RATs and carriers, which should be considered in the similarity metric computation.

### SUMMARY OF INVENTION

In view of the above an object of the present invention is to provide a similarity metric having increased flexibility in handling of different radio configuration set-ups of a heterogeneous network and to describe related use scenarios.

According to one aspect of the present invention there is provided a similarity metric for use in processing of measurement data characterizing operation of a heterogeneous multi-carrier network. Radio measurement values reflecting radio access conditions during different measurement time intervals for at least one mobile terminal having radio access to the heterogeneous multi-carrier network are aggregated into radio measurement scans. Further, for every radio measurement scan related radio measurement configurations prevailing at the time of measurement of the corresponding radio measurement values are aggregated into a radio measurement configuration scan. Then the similarity metric is calculated for a pair of radio measurement scans to generate knowledge on radio coverage in the heterogeneous wireless network in a customized manner through reference to radio measurement configuration scans associated with the pair of radio measurement scans for which similarity metrics is to be calculated.

According to another aspect of the present invention there is provided a method of processing measurement data delivered from a heterogeneous multi-carrier network to a measurement data processing apparatus. The method comprises a step of aggregating radio measurement values reflecting radio access conditions during different measurement time intervals for at least one mobile terminal having radio access to the heterogeneous multi-carrier network into radio measurement scans. Further, the method comprises a step of aggregating for every radio measurement scan related radio measurement configurations prevailing at the time of measurement of the corresponding radio measurement values into a radio measurement configuration scan. Still further, the method comprises a step of calculating similarity metrics for pairs of radio measurement scans to generate knowledge on radio coverage in the heterogeneous wireless network, wherein similarity metrics are customized to radio measurement conditions through reference to radio measurement configuration scans associated with pairs of radio measurement scans for which similarity metrics are calculated.

According to yet another aspect of the present invention there is provided a measurement data processing apparatus for processing of measurement data delivered from a heterogeneous multi-carrier network to the central network node. The measurement data processing apparatus comprises a first aggregation unit adapted to aggregate radio measurement values reflecting radio access conditions during different measurement time intervals for at least one mobile terminal having radio access to the heterogeneous multi-carrier network into radio measurement scans. Further the measurement data processing apparatus comprises a second aggregation unit adapted to aggregate for every radio measurement scan related radio measurement configurations prevailing at the time of measurement of the corresponding radio measurement values into a radio measurement configuration scan. Still further, the measurement data processing apparatus comprises a processing unit adapted to calculate similarity metrics for pairs of radio measurement scans to generate knowledge on radio coverage in the heterogeneous wireless network, wherein similarity metrics are customized to radio measurement conditions through reference to radio measurement configuration scans associated with pairs of radio measurement scans for which similarity metrics are calculated.

### BRIEF DESCRIPTION OF DRAWING

In the following different embodiments of the present invention will be described with reference to the drawing in which

FIG. 1 shows a transmitter-receiver geometry to illustrate the present invention;

FIG. 2 shows ratios of terminal specific gains as a function of displacement of terminals in one dimension;

FIG. 3 shows ratios of terminal specific gains as a function of displacement of terminals in two dimensions;

FIG. 4 shows a schematic diagram of a measurement data processing apparatus according to the present invention;

FIG. 5 shows a flowchart of operation of the measurement data processing apparatus shown in FIG. 1;

FIG. 6 shows a further flowchart of operation of the measurement data processing apparatus shown in FIG. 1;

FIG. 7 shows a further flowchart of operation of the measurement data processing apparatus shown in FIG. 1;

FIG. 8 shows a further flowchart of operation of the measurement data processing apparatus shown in FIG. 1;

FIG. 9 shows an example of application of the present invention;

FIG. 10 shows a further example of application of the present invention;

FIG. 11 shows a further example of application of the present invention; and

FIG. 12 shows a further example of application of the present invention.

### DETAILED DESCRIPTION OF INVENTION

In the following the present invention will be described with reference to the drawing and examples thereof. It should be noted that clearly the present invention may also be implemented using variations and modifications thereof which will be apparent and can be readily made by those skilled in the art without departing from the scope of the present invention as defined by the claims. E.g., functionalities described above may be realized in software, in hardware, or a combination thereof.

Accordingly, it is not intended that the scope of claims appended hereto is limited to the description as set forth herein, but rather that the claims should be construed so as to encompass all features that would be treated as equivalent thereof by those skilled in the art to which the present invention pertains.

Generally, the present invention provides a similarity metric for use in a measurement data processing apparatus, e.g., a machine learning system. The similarity metric differentiates between radio measurements with different reliabilities of information value. Thus, a learning method could assign high weight to radio measurement values that are known to be reliable, and ignore other ones, which just increase computation complexity and contribute minimal information. Hence even a machine learning algorithm can incorporate system knowledge or models.

Thus, the present invention addresses heterogeneous mobile networks. Here, the term heterogeneous network primarily means that small and large cells are mixed in the cellular network especially which target high peak bit rates and capacity. Thus, the number of small cells is going to be large, as well as, the radio access technologies RATs will employ high carrier frequencies together with beam forming. In case of small cells and narrowly formed beams the RSS might change rapidly as terminals travel over a short distance. Therefore, in such case, the visibility of the cell/beam is the primary information to location fingerprinting, and the actual RSS value is supplementary.

In the following it will be shown how the similarity index for heterogeneous networks is composed so that the visibility and RSS information that terminals report can be synthesized in a single-valued similarity index, which is more accurate than customary interdisciplinary indexes.

In more detail, according to the present invention there is provided a similarity metric for use in processing of measurement data characterizing operation of a heterogeneous multi-carrier network.

Radio measurement values reflecting radio access conditions during different measurement time intervals for at least one mobile terminal having radio access to the heterogeneous multi-carrier network are aggregated into radio measurement scans.

Depending on hardware capabilities a typical case here would be that a mobile receiver being operated in the heterogeneous network measures different radio access technologies RAT and radio carriers in a sequential manner and that the measurement results are united in a measurement scan which are close enough in time. Therefore it is possible to compare one measurement scan from one time interval to another measurement scan from another time interval or from another terminal from any time interval.

Then, for every radio measurement scan related radio measurement configurations prevailing at the time of measurement of the corresponding radio measurement values are aggregated into a radio measurement configuration scan.

According to the present invention the similarity metric is calculated for a pair of radio measurement scans to generate knowledge on radio coverage in the heterogeneous wireless network in a customized manner through reference to radio measurement configuration scans associated with the pair of radio measurement scans for which similarity metrics is to be calculated.

Preferably, radio measurement configurations which are aggregated into radio measurement configuration scans are described as combinations of radio access technology/carrier/cell/beam set-ups, the i-th radio access technology/carrier/cell/beam identification is represented as an index cᵢ ε C, and C is the identification set of all radio access technology/carrier/cell/beam combinations used in the heterogeneous multi-carrier network.

According to the present invention the similarity metric may divide in to a first part for identification of qualitative similarity between radio measurement scans and a second part for quantitative comparison of different radio measurement scans.

Thus, the similarity metric according to the present invention uses a first visibility metric J as qualitative part of the similarity metric reflecting similarity of radio measurement configurations identified in two different radio measurement configuration scans.

Here, if a large variety of wireless services available at the location of a terminal, i.e. the terminal detects many small cells/beams of heterogeneous, multi-RAT, multi-carrier network, then the Jaccard index is a suitable similarity metric to start with. In 3GPP networks, the terminals regularly report the measured RSS values from different RAT/carrier combinations, and, if those measurements are sufficiently close in time, then can be united in one common record on the network control side. This record is tagged by the terminal id and time stamp, and it is interpreted as the RSS scan at the instantaneous location of terminal.

For example, such a field scan might contain all the measured RSS values from nearby wireless base stations detected e.g. in the past 10 seconds. The terminal may take measurements on certain RATs/carriers periodically, or can only report when it observes significant changes in some field sample. Also, the terminal may take measurements on a trigger from the network side. From the point of view of localization fingerprinting, the more frequent and wider sampling of RATs/carriers is the better, but for performance and efficiency reasons, field scans in high spatial and temporal density are not likely.

It is desirable though that sampling should match the motion speed of users in time and the variation of coverage in space.

If only visibility is concerned, then the list of the seen signal sources is used in the form of a set of ids, where each id is unique and corresponds to the source of received signal, i.e. the id of a certain RAT/carrier/cell/beam combination.

In more detail, a non-empty set S of first indices represents a first radio measurement configuration scan, a non-empty set T of second indices represents a second radio measurement configuration scan, and the first visibility metric J is a Jaccard type metric defined for the two sets S and T as a quotient of a first value representing the intersection of S and T and a second value representing the union of S and T.

The first visibility metric of the similarity metric is a real value

$$J ( S , T ) = \frac{\vert S ⋂ T \vert}{\vert S ⋃ T \vert}$$

$$with$$

$$0 \leq J ( S , T ) \leq 1.$$

One further suggestion of the present invention is to add enhancements to this metric so that the proposed metric should individually weigh each detected RAT/carrier/cell/beam combination. The weight may reflect the coverage area of a particular combination or simply it can be a preset real value in (0,1], which is automatically computed by a rule using the type of RAT, carrier and other cell/beam specific parameters. Or, as an alternative if the approximate coverage area of each RAT/carrier/cell/beam combination is known, e.g. which can be computed with a radio planning tool, then an inverse proportionality between the weight and the coverage area can be established on the basis that the information on the recipient location is less in case of a large macro cell than in case of a small cell. Some of the interdisciplinary distance metrics, such as Cosine similarity, Pearson coefficient, apply weighted summations in their formulas, but they do it in order to weigh certain terms according to their statistical variability.

In more detail, the similarity metric according to the present invention may individually weights the index cᵢ ε C of i-th radio access technology/carrier/cell/beam identification with a weight wi ε (0, 1].

The weight wi ε (0, 1] may be calculated according to the type of the i-th radio access technology/carrier/cell/beam identification and related system parameters.

Further, the weight wi ε (0, 1] may be calculated as a value having an inverse proportional relationship to the approximate coverage are i-th radio access technology/carrier/cell/beam identification.

Here, a distance metric is usually multi-dimensional so it is a composite of distances measured in many dimensions. In radio location fingerprinting, a single dimension of the imaginary metric distance is derived from the comparison of a pair of RSS measurements. Hence, it is desirable that the imaginary distance derived from the RSS values should be related to the physical displacement in some form. It is hard to establish a linear relationship between the imaginary and physical distances, but the relationship can be made monotonic. And since the number of available dimensions is large, i.e. the RSS scans contain many RAT/carrier/cell/beam combinations, the multi-dimensional imaginary distance of RSS scans will be proportional to the physical distance of scanning locations.

It is reasonable to assume that the relationship between the imaginary distance metric of RSS fingerprints and the physical displacement of measurement locations is monotonic since the RSS monotonically decreases with distance according to LOS and other cellular propagation models. Even if antenna pointing and orientation are considered the monotonicity assumption still applicable for NLOS and for most practical situations. One may expect that RSS scans recorded at close locations are similar, so the RSS readings on the same signals do not deviate much.

Each signal source, which is measured in both RSS scans, adds a dimension to the distance metric, and the more dimensions exist, the better the imaginary distance metric reflects physical distance.

Assuming a weighting as outlined above, then the first visibility metric of the similarity metric is calculated as a real value according to

$${J}^{′} ( S , T ) = \frac{{Σ}_{\{ j \text{:} {c}_{j} ∈ S ⋂ T \}} {w}_{j}}{{Σ}_{\{ k \text{:} {c}_{k} ∈ S ⋃ T \}} {w}_{k}} .$$

Further to the above, the similarity metric according to the present invention may use a second numerical metric J′ as quantitative part of the similarity metric from information carried by the measurement values of radio measurement scans. This allows considering the radio measurement values themselves so as to refine the similarity metric in a customized manner.

Preferably, a linearization transformation is applied to measurement values of radio measurement scans assuming a propagation model with a real-valued propagation constant, γ≥2, wherein the received power p is a nonlinear function of range r, such that p ∝ r^{-γ} and a pre-scaling p^{γ} brings the RSS values closer to linearity with respect to physical displacement. The pre-scaling value may be a value of p^{-0.5}.

According to the present invention it is preferable that the RSS values go through a linearizing transformation before entering the index computation. In order to project the RSS to physical distance, let us assume a generic, simple propagation model with a real-valued propagation constant, γ≥2. With these assumptions, the received power p is a nonlinear function of range r, such that p ∝ r^{-γ}. Hence a pre-scaling p^{γ} brings the RSS values closer to linearity with physical displacement. For instance, in case of LOS, the value p^{-0.5} becomes linear with range, but even in case of γ>2, the transformed value gets closer to linear, at least. When differences of such transformed values are used in the summations of a distance metric, the imaginary dimensions of the distance metric will be proportional to incremental displacement and less dependent on the ranges to signal sources.

Further, the distance dependence of RSS can be mostly exploited for localization in case of sectorized macro cells, since the directional variation of wide sector beams influence less the RSS variability. In case of beamforming, the directional pattern of antenna beam is the dominant cause of spatial variations in RSS. And there are uncertainty factors influencing the RSS on the terminal side, as well. Namely, the antenna and receiver gain can also widely spread for different makes and types of terminals and such gain differences distort the distance metric. The easy solution would be to normalize each RSS values first by a RAT/carrier-, then by a terminal-specific offset value, but the establishment and maintenance of a data base to store such normalizing factors is just not feasible in network management.

Further, during calculation of the second numerical metric J′ as quantitative part of the similarity metric from information carried by the measurement values of radio measurement scans matching radio access technology and carrier-specific sub-sets in a pair of radio measurement scans S and T for which a similarity metric is to be calculated may be identified for subsequent comparison of the identified sub-sets to each other.

Assuming that radio measurement scans S and T comprise logarithmic radio signal strength values {sᵢ, sⱼ, sₖ, . . . } and {tₗ, tₘ, tₙ, . . . }, respectively, such that the related cell/beam combinations cᵢ, cⱼ, cₖ, cₗ, cₘ, cₙ, . . . are elements of C, the similarity metric uses
an extended radio measurement scan S′={sᵢⱼ, sᵢₖ, sⱼₖ, . . . } with sᵢⱼ=sᵢ−sⱼ, . . . , such that its members are pairwise combinations of the original members of the radio measurement scan S while ignoring pairs with are pairwise combinations of themselves and accounting for other combinations once;
an extended radio measurement scan T′={tₗₘ, tₗₙ, tₘₙ, . . . } with tₗₘ=t₁−tₘ, . . . , such that its members are pairwise combinations of the original members of the radio measurement scan T while ignoring pairs with are pairwise combinations of themselves and accounting for other combinations once; and
common index pairs pq ε {ij, ik, jk, lm, ln, mn, . . . } in extended radio measurement scan S′ and in the extended radio measurement scan T′ to identify matching radio access technology and carrier-specific sub-sets.

An example with a single-RAT, single-carrier example. Let the set of possible cell/beam combinations denoted with C={c₁,c₁, . . . c₁₀} and two different measurement scans are to be compared, T={t₃,t₅,t₈} and S={s₃,s₅,s₇} where tᵢ and sⱼ are the logarithmic RSS values in field scans T and S, respectively.

Thus both scans contains 3 measurements out of the 10 possible beams, and there is a partial overlap in the sets, both scans contains measurement on c₃ and c₅.

In the next step, there is created the extended set T′, such that its members are the pairwise combinations of the original members of scan T. The new set then is T′={t₃₅,t₃₈,t₅₈} where, e.g. t₅₈=t₅−t₈=ΔRSS₅₈^{T}. The elements that are created as pairwise combinations of themselves are ignored, so t₃₃,t₅₅,t₈₈ are omitted from the newly formed sets.

The pairwise combination should be counted once since the information carried by a pairwise combination does not depend on the order within the pair. Therefore, a non-binding convention could be that the pair is enrolled with the smaller index first.

The extended set T′ is typically larger than its origin set T due to the non-linearly growing number of potential combinations, namely, there are 1(l−1)/2 members in the additional set if the number of elements in the origin set is l. The increased set size requires extra storage capacity, therefore, it is worthwhile to get rid of the less reliable elements, e.g. the ones outside of the [−20 dB,20 dB] domain for reasons mentioned above.

Then create the extended set S′ in a similar manner from S, so S′={s₃₅, s₃₇, s₅₇}, where, e.g. s₃₅=s₃−s₅=ΔRSS₃₅^{S}.

Further to the above, generally in the extended radio measurement scans S′ and T′ from different mobile terminals there are identified radio measurements RSSₚ and RSS_{q} from cell/beam combinations p and q which use a same radio access technology/carrier. A pairwise ratio of the two values RSSₚ/RSS_{q} is calculated such that a mobile terminal-specific gain drops out from the quotient RSSₚ/RSS_{q} which is equivalent to a difference at log scale in dB according to ΔRSS_{pq}=RSS_{p_dBm}−RSS_{q_dBm}.

In more detail, according to the present invention there is proposed processing which does not need to know terminal-specific parameters. Instead of using the RSS values themselves, let us say, RSSₚ and RSS_{q}, from base station cell/beam combinations p and q respectively, one can use the pairwise ratios of the two values RSSₚ/RSS_{q}. The terminal-specific gain drops out from this quotient. It is also assumed that RSSₚ and RSS_{q} belong to the same RAT/carrier-related subset, so neither the carrier and RAT-specific gain differences impact ratios formed within a subset. The quotient is equivalent to a difference at log scale, e.g. the result can be expressed in dB, ΔRSS_{pq}=RSS_{p_dBm}−RSS_{q_dBm}.

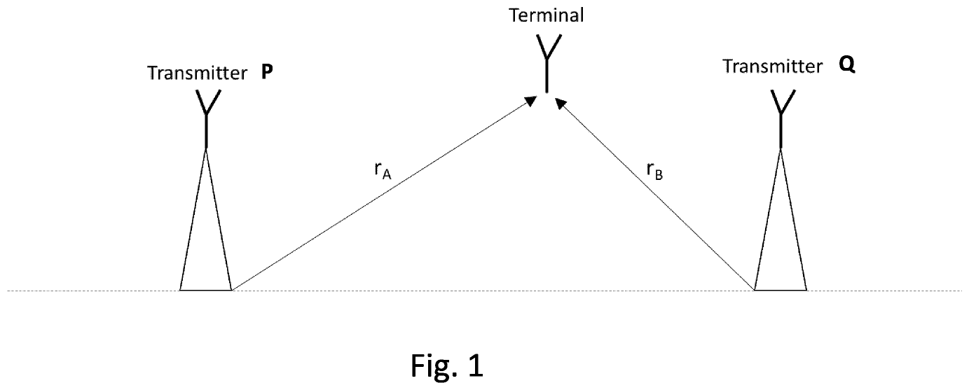

FIG. 1 shows a transmitter receiver geometry to illustrates this aspect of the present invention in more detail.

As shown in FIG. 1, the terminal has a positional relationship to at least to transmitters, e.g., base stations. The positional relationship may be described by using a distance between the mobile terminal and each of the transmitters.

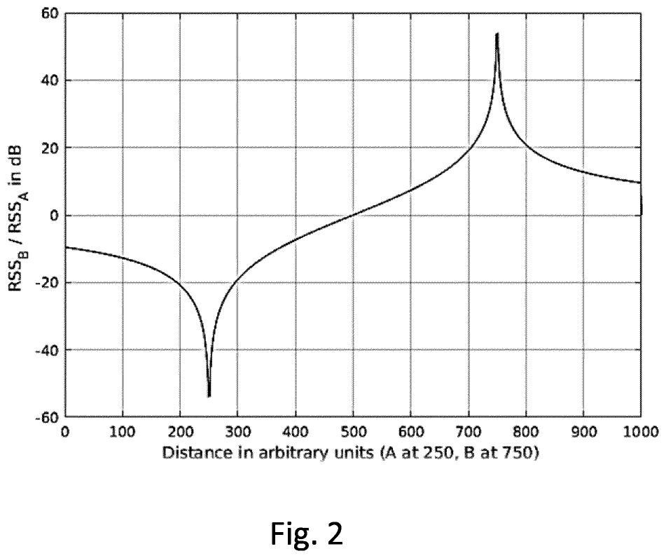

FIG. 2 shows ratios of terminal specific gains as a function of displacement of terminals in one dimension.

As shown in FIG. 2, if a terminal moves along the straight line connecting the two transmitters, then the displacement-dependent factor of ΔRSS_{pq} is close to linear along the line between the transmitter locations though not in their close vicinity. The linearity holds well, e.g., in the ±20 dB domain along the line.

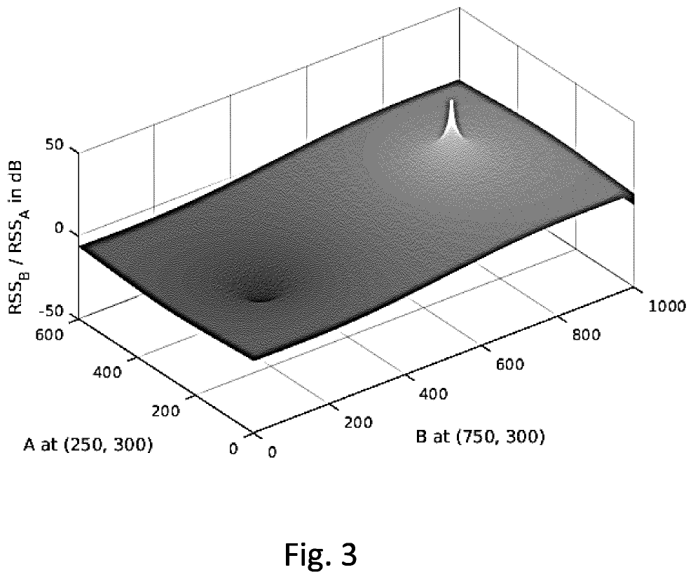

FIG. 3 shows ratios of terminal specific gains as a function of displacement of terminals in two dimensions in particular the log-scale RSS difference from the two transmitters, A and B in the surrounding area.

As shown in FIG. 3, along the circular contour curves the difference is constant, so if two RSS scans contain the same RSS difference from transmitters A and B, then they are on the same contour curve. The contour curves are equally spaced along the line connecting the two transmitters. Hence a linear displacement of the receiver along this line appears as a proportional change in the RSS difference.

As shown in FIG. 3, if one looks over the area surrounding the transmitters, then the displacement-dependency is still monotonic though antenna directionality can strongly influence ΔRSS_{pq} when the displacement has a tangential component to the transmitter locations.

As shown in FIG. 3, one of the contour lines mark the points where Terminal T measures a certain log-scale RSS difference, ΔRSS_{pq}^{T}, from isotropic transmitters p and q. If another terminal, S, measures the same difference, ΔRSS_{pq}^{S}=ΔRSS_{pq}^{T} then it must reside close to that contour line regardless of the receiver gain of any of the two terminals. Though the terminal antennas also have directional variation in gain, but less than the base stations since wide beams have lower gain. Body shadowing, terminal orientation, interference, etc., all can influence the measurements, yet if differences ΔRSS_{pq}^{S} and ΔRSS_{pq}^{T} close to each other, then the recording locations of these RSS scans should fall on a stripe along such a contour line. And if a pair of signal sources is seen in both RSS scans, then the log-scale RSS difference from those signal sources can be used as one comparing dimension in the overall distance metric, as described next.

In view of the above, let T and S two RSS field scans by two different terminals as before. If both field scans have RSS measurements from base station cell/beam combinations p and q in the same RAT/carrier, then formulate the difference Δ_{pq}^{ST}=ΔRSS_{pq}^{S}−ΔRSS_{pq}^{T}. Δ_{pq}^{ST} will not depend on terminal-specific receiver gain because neither ΔRSS_{pq}^{T}, nor ΔRSS_{pq}^{T} do. A small absolute difference of Δ_{pq}^{ST} means that scans T and S originate close from the same contour line, while large difference means they originate from points many contour lines between. On the other hand, the larger the difference, the more unreliable the relation to physical displacement. E.G., no line of sight NLOS propagation on one of the transmission legs may distort the range dependence of Δ_{pq}^{ST}. Therefore, it is possible to filter out unreliable samples by excluding RSS values below a RAT-specific threshold level. Similarly, we can drop Δ_{pq}^{ST} values from consideration if they are out of the range of, e.g., [−20 dB, 20 dB]. Hence, we limit the number of dimensions in comparisons, but what are left become more reliable.

Further to the above, according to the present invention it is suggested to map the Δ_{pq}^{ST} distances in a range of [−20 dB, 20 dB] into a real value falling in the domain of [0,1]. Then we use the transformed values as dimensions of the distance metric. More specifically, we form the transformed variable v_{pq} expressing the closeness of RSS differences.

As shown In FIG. 3, the variable v_{pq} is proportional to how many contour lines are between the physical locations where the two RSS scans were recorded. So, let

$${v}_{pq}^{ST} = 1 - \frac{\vert {Δ}_{pq}^{ST} \vert}{40 dB}$$

And since v_{pq}^{ST}=v_{pq}^{TS}=v_{qp}^{ST}=v_{qp}^{ST}, a single real value in [0,1] becomes one of the similarity dimensions. A dimension means that the same cell/beam pair measured in both radio measurement scans that are the subjects of comparison. This metric is a numerical index in the sense that it is based on real values, not like the visibility index described before, which is a comparison of categorical variables, i.e., the category is the beam id with possible values of “visible” or “not visible”.

According to the present invention the second numerical metric J′ is thus defined by
Calculation of a value Δ_{pq}^{S′T′}=ΔRSS_{pq}^{S′}−ΔRSS_{pq}^{T′},
Dropping out of values Δ_{pq}^{S′T′} from consideration if they are out of the range of [−lower bound in dB, upper bound in dB], preferably −20 dB to 20 dB,
Mapping Δ_{pq}^{S′T′} in the range of [−lower bound in dB, upper bound in dB] to a real value in [0, 1] by

$${v}_{pq}^{{S}^{′} {T}^{′}} = 1 - \frac{\vert {Δ}_{pq}^{{S}^{′} {T}^{′}} \vert}{upper bound in dB - lower bound in dB}$$

and
Determining the second numerical metric J″ as quantitative part of the similarity metric as

$${J}^{″} ( {S}^{′} , {T}^{′} ) = \frac{{Σ}_{\{ pq \text{:} {s}_{pq} ∈ {S}^{′} ⋀ {t}_{pq} ∈ T ′ \}} {v}_{pq}^{S ′ T ′}}{{ρ}_{\{ pq \text{:} {s}_{pq} ∈ S ′ ⋀ {t}_{pq} ∈ T ′ \}} 1} ɛ ( 0 , 1 ]$$

with index pairs p,q:p≠q that occur in both the extended radio measurement S′ and the extended radio measurement scan T′.

The similarity index then computed on the alternative sets such that there are search members with the same index pairs in sets T′ and S′. In the example, there is one such common index pair {s₃₅,t₃₅}. Let us compute the similarity on this pair as

$${v}_{35}^{S ′ T ′} = 1 - \frac{\vert {s}_{35} - {t}_{35} \vert}{40 dB} ,$$

remember that the elements with indices of p=q have been excluded, they are already considered in the visibility component of the index. Then in the general case, the RSS-based numeric similarity index is formulated as:

$${J}^{″} ( {S}^{′} , {T}^{′} ) = \frac{{Σ}_{\{ kn \text{:} {s}_{kn} ∈ {S}^{′} ⋀ {t}_{kn} ∈ T ′ \}} {v}_{kn}^{S ′ T ′}}{{Σ}_{\{ kn \text{:} {s}_{kn} ∈ S ′ ⋀ {t}_{kn} ∈ T ′ \}} 1}$$

One may interpret the above formula which compares two RSS scans as follows. In the context of numerical comparison, the RSS scans are similar if they contain at least one log-scale RSS difference from the same pair of transmitters. The numerical similarity index will have as many dimensions as many transmitter pairs are shared by the two RSS scans. In the sum of the nominator, each dimension is a similarity measure of RSS differences existing in both scans. The single dimensional similarities are computed with the formula for v_{pq}^{ST}.

E.g., if the RSS differences from the same transmitters are the same in both scans, then the perfect match is awarded by unit weight. A worse match of RSS differences adds less than unit weight in that dimension of the index. Remember that the RSS difference is used instead of the RSS values themselves in order to avoid terminal-specific gain offsets. The multidimensional numerical similarity index is the arithmetic mean of the single dimensional similarities. The summations both in the nominator and numerator go through the same index pairs of transmitter, i.e. through p,q:p≠q index pairs, that occur in both T′ and S′. Hence the formula results in a number in (0,1].

According to the present invention it is also proposed to combine or equivalently synthesize the first qualitative part of the similarity metric and the second quantitative part of the similarity metric into an overall final result.

Here, one option for the synthesis of the first visibility metric J/J′ as qualitative part of the similarity metric and the second numerical metric J″ as quantitative part of the similarity metric into an overall similarity index M of a pair of radio measurement scans to be compared may be achieved according to

M(S,T)=μᵥJ/J′(S,T)+μᵣJ″(S′,T′)

with μᵥ+μᵣ=1 and 0≤M(S,T)≤1.

Here, if positive weights, such that μᵥ+μᵣ=1, are chosen, then 0≤M(S,T)≤1. This level of weighting is at a higher level than the weighting applied within the terms themselves. As discussed above, in case of certain RATs, e.g. with narrow beams or small cells, the visibility is more informative, while in other RATs, such as the ones with large sectorized macro cells, the RSS-based localization might be more effective. The weights μᵥ, μᵣ should be tuned accordingly.

Another option for the synthesis of the first visibility metric J/J′ as qualitative part of the similarity metric and the second numerical metric J″ as quantitative part of the similarity metric into an overall similarity index M is to weight different radio access technology and carrier combinations (r₁, r₂, . . . , rₖ} and related quantitative similarity metrics {J″₁, J″₂, . . . J″ₖ} according to

M(S,T)=μᵥJ/J′^{(S,T)}+Σᵢ₌₁^{k} μᵣᵢ J″₁(S′ᵢ, T′ᵢ) ε (0, 1]

wherein the extended radio measurement scans S′ᵢ, T′ᵢ are formed from the radio access technology/carrier-specific subsets of S and T, and μᵣᵢ are radio access technology/carrier-specific weights adding up to a value of 1 and which the network operator sets in order to control the relative importance of the radio access technology/carrier-specific subsets in the similarity metric.

Thus, the visibility part of the similarity index, J′, is general to any kind of RAT/carrier/cell/beam combinations, just each such combination should have a unique id in the category sets of the RSS scans. The RSS-based numerical part of the index, J″, is made specific to the RAT/carrier since the various terminals have different gains at different RATs and carrier frequencies and measurements from one RAT is not comparable to measurements from another RAT.

In conclusion, the similarity metric proposed according to the present invention is a special metric with customized features in order to fit the metric for fingerprinting in heterogeneous multi-carrier networks. The similarity metric is a synthesis of categorical and numerical metrics. The categorical metric is based on the Jaccard similarity index, which measures the similarity between two finite sets by the dividend of the element count of the intersection by the element count of the union of the two sets. In case of radio fingerprinting, an element of a set is a unique id of one RAT/carrier/cell/beam combination in the radio measurement scan. This index only uses the visibility information from the radio measurement scan, which means that the id of a visible beam is in or not in a set regardless of the radio measurement on that beam, e.g., a radio signal strength RSS measurement. Hence the so-called categories of the metric are the beam ids with two possibilities, “in” or “out”.

On the other hand, the numerical similarity metric uses the numerical values of the radio measurements from the radio measurement scans. The radio measurement values of a field scan are separated into subsets according to the RAT/carrier combination they belong to because the various cell/beam RSS values in such a subset are measured through the same receiver so that there is no receiver specific offset among them.

Typically, the two radio measurement scans that the numerical part of the similarity metric compares originate from different terminals. Therefore, e.g., an offset among the actual absolute RSS readings is highly probable even if the terminals measured on the same signal. So instead of using the absolute values, one can use pairwise ratios of radio measurement values from the subset. This way the terminal specific gains do not influence the subset comparisons, though the price is that the subsets of pairwise ratios are larger than the original subsets of radio measurement values. But this only demands more storage space for the algorithm, since only part of the elements of the increased subsets will be the subject of subsequent comparisons at a time.

The radio measurement values, e.g., RSS values are commonly expressed in dBm, therefore an extraction at log scale is equivalent to taking ratio at linear scale. The ratio in logarithmic scale is expressed in dB. It happens to be that such a ratio at log scale is closely related to physical distances, when a terminal moves along the two transmitters.

An alternative to eliminate terminal-specific would be to learn these offsets and store them in a central data base and to normalize arriving RSS on the fly. However, it would be hard to track the appearance and disappearance of terminals on a regional network level.

The concept of the proposed metric is that it is synthetized once from the visibility information then from the information carried by the concrete radio measurement values where applicable. The visibility part of the index is an evolved version of the original Jaccard index, with the addition that the elements in the compared sets are weighted. Some elements of the compared sets will have larger, others smaller contribution in the summations. The weighting system reflects the reliability of radio measurements, e.g., the RAT/carrier/cell/beam combinations with stronger and less noisy signal get higher weights.

The numerical component of the similarity index uses the above described RSS ratios in logarithmic scale. The RSS ratios are in RAT- and carrier-specific subsets of the field scan, and the matching subsets of two radio measurement RSS scans, if they exist, are compared to each other. Such a comparison itself is also composed from weighted sums, where the weights are derived from the value by value distances of subset members.

So, as a result of the previous steps, we will have a metric component from the visibility information and additional metric components from the comparisons of RAT/carrier-specific subsets. The count of latter components is at most as many as RAT/carrier combinations exist in the network. Then all these metric components are synthesized to formulate the overall similarity index of the compared radio measurement scans. The synthesis of components can be further controlled by a top-level weighing system which allows to differentiate among RAT/carrier combinations. The purpose of such weighing can, e.g., emphasize information from beams with smaller coverage areas compared to beams with large coverage areas. Beams with small footprint have a better positioning potential. Since a network operator can easily have estimates of the coverage zones of their network components (cells and beams), such weights can be automatically generated.

According to the present invention there are thus proposed similarity metrics primarily to be used in radio fingerprinting. This similarity metric is suited for RSS measurements from heterogeneous, multi-RAT, multi-carrier networks, where the RSS values have RAT/carrier and terminal specific offsets, so direct comparisons of RSS values do not get accurate results.

Moreover, according to the present invention the information value of different RATs and carriers is not the same when the similarity of RSS field scans is estimated. With the proposed filtering and weighing system according to the present invention it is achieved that
terminal-specific factors do not distort the similarity value between to RSS field scans,
noisy and weak signals get less weight compared to strong signals,
multi-RAT, multi-carrier measurements can be combined into one set before compared to another set,
existing knowledge on the coverage areas of individual cells/beams can be taken into account in order to make fingerprinting more accurate, and that
the visibilities of beams are treated separately and hence can be differently emphasized if the visibility of certain beams carry more or less information on terminal locations.

In the following there will be described further details of the similarity metric and application thereof to different measurement scenarios.

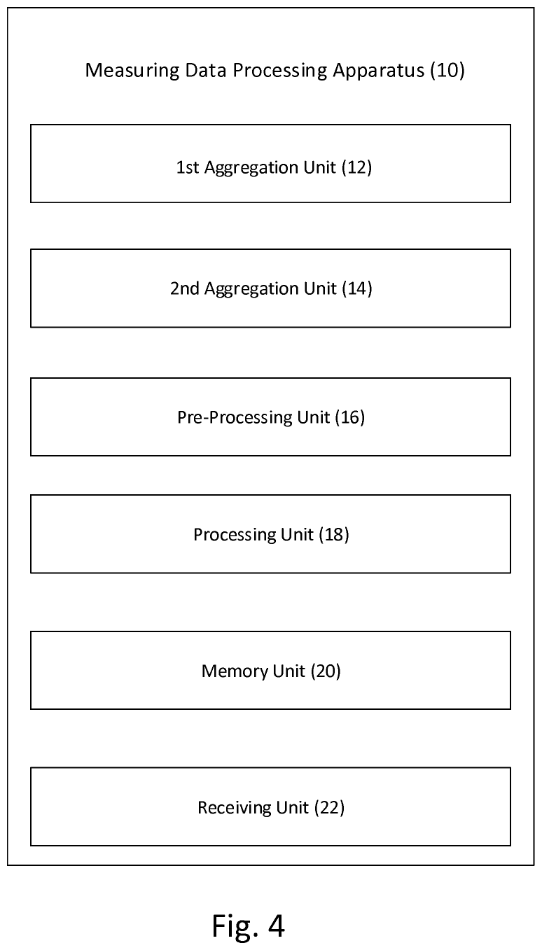

FIG. 4 shows a schematic diagram of a measurement data processing apparatus according to the present invention.

As shown in FIG. 4, the measurement data processing apparatus according to the present invention comprises a first aggregation unit 12, a second aggregation unit 14, a pre-processing unit 16, a processing unit 18, a memory unit 20, and a receiving unit 22.

Operatively, the first aggregation unit 12 is adapted to aggregate radio measurement values reflecting radio access conditions during different measurement time intervals for at least one mobile terminal having radio access to the heterogeneous multi-carrier network into radio measurement scans.

Further operatively, the second aggregation unit 14 is adapted to aggregate for every radio measurement scan related radio measurement configurations prevailing at the time of measurement of the corresponding radio measurement values into a radio measurement configuration scan.

Further operatively, the pre-processing unit 16 is adapted to realize pre-processing steps on the radio measurement scan and the radio measurement configuration scan as will be explained in the following

Further operatively, the processing unit 18 is adapted to calculate similarity metrics for pairs of radio measurement scans to generate knowledge on radio coverage in the heterogeneous wireless network, wherein similarity metrics are customized to radio measurement conditions through reference to radio measurement configuration scans associated with pairs of radio measurement scans for which similarity metrics are calculated as outlined above.

Further operatively, the memory unit 20 is adapted to store any type of data involved in the determination of the similarity metric according the present invention.

Further operatively, receiving unit 22 is adapted to receive radio measurement values reflecting radio access conditions during different measurement time intervals from at least one mobile terminal having radio access to the heterogeneous multi-carrier network periodically, upon trigger from a central network node, and/or upon changes of the radio access conditions exceeding a predetermined threshold.

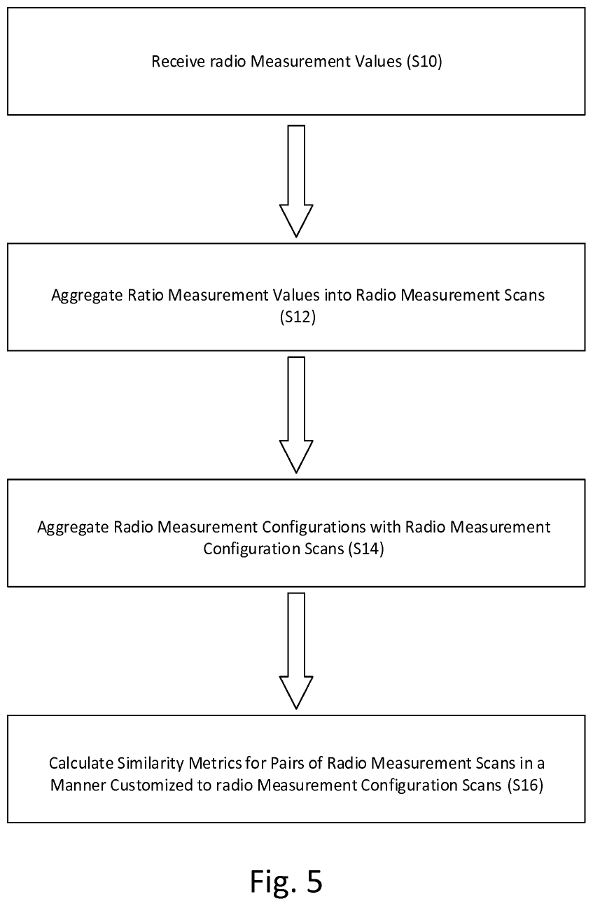

FIG. 5 shows a flowchart of operation of the measurement data processing apparatus 10 shown in FIG. 4.

As shown in FIG. 5, the operation of the measurement data processing apparatus 10 comprises a step S10, executed by the receiving unit 22, of receiving radio measurement values reflecting radio access conditions during different measurement time intervals from at least one mobile terminal having radio access to the heterogeneous multi-carrier network. The step S10 may be executed periodically, upon trigger from the central network node, and/or upon changes of the radio access conditions exceeding a predetermined threshold.

As shown in FIG. 5, the operation of the measurement data processing apparatus 10 comprises a step S12, executed by the first aggregation unit 12, of aggregating radio measurement values reflecting radio access conditions during different measurement time intervals for at least one mobile terminal having radio access to the heterogeneous multi-carrier network into radio measurement scans.

Preferably, the operation of the measurement data processing apparatus 10 may include a step of tagging at least one radio measurement scan with a mobile terminal identification and a time stamp to identify the mobile terminal delivering measurement values of the radio measurement scan and a related measurement time interval.

As shown in FIG. 5, the operation of the measurement data processing apparatus 10 comprises a step S14, executed by the second aggregation unit 14, of aggregating for every radio measurement scan related radio measurement configurations prevailing at the time of measurement of the corresponding radio measurement values into a radio measurement configuration scan.

As shown in FIG. 5, the operation of the measurement data processing apparatus 10 comprises a step S16, executed by the processing unit 18, of calculating similarity metrics for pairs of radio measurement scans to generate knowledge on radio coverage in the heterogeneous wireless network, wherein similarity metrics are customized to radio measurement conditions through reference to radio measurement configuration scans associated with pairs of radio measurement scans for which similarity metrics are calculated.

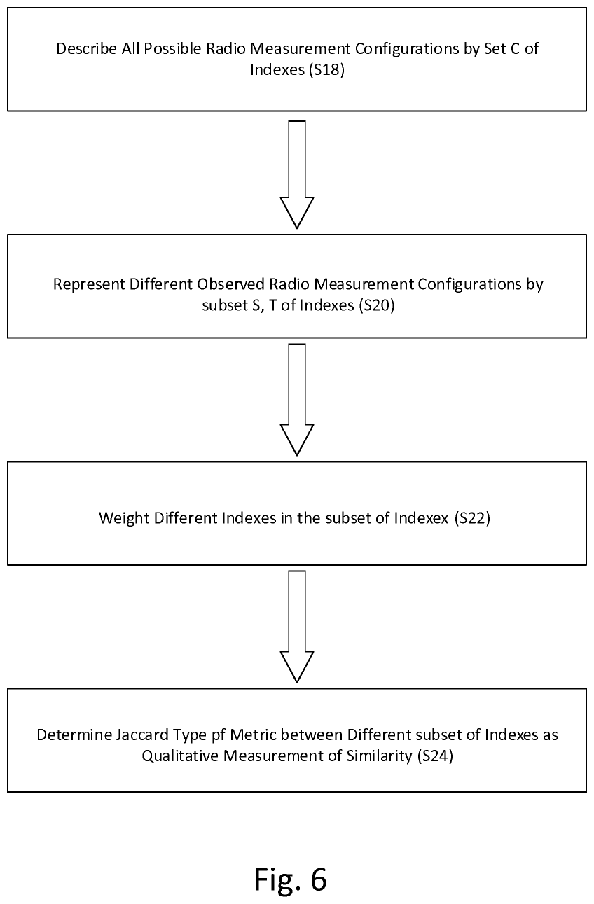

FIG. 6 shows a further flowchart of operation of the measurement data processing apparatus 10 shown in FIG. 4, in particular with respect to calculation of a first visibility metric J as qualitative part of the similarity metric reflecting similarity of radio measurement configurations identified in two different radio measurement configuration scans.

As shown in FIG. 6, the operation of the measurement data processing apparatus 10 comprises a step 818, executed by the processing unit 18, of describing the radio measurement configurations aggregated into radio measurement configuration scans as combinations of radio access technology/carrier/cell/beam set-ups, wherein the i-th radio access technology/carrier/cell/beam identification is represented as an index cᵢ ε C and C is the identification set of all radio access technology/carrier/cell/beam combinations used in the heterogeneous multi-carrier network:

As shown in FIG. 6, the operation of the measurement data processing apparatus 10 comprises a step S20, executed by the processing unit 18, generating a non-empty set S of first indices to represent a first radio measurement configuration scan, and of generating a non-empty set T of second indices to represent a second radio measurement configuration scan.

As shown in FIG. 6, the operation of the measurement data processing apparatus 10 comprises a step S22, executed by the processing unit 18, of individually weighting the index cᵢ ε C of i-th radio access technology/carrier/cell/beam identification with a weight wi ε (0, 1].

Preferably, the weight wi ε (0, 1] reflects a type of the of i-th radio access technology/carrier/cell/beam identification and related system parameters.

Further, preferably, the weight wi ε (0, 1] the value is calculated as a value having an inverse proportional relationship to the approximate coverage are i-th radio access technology/carrier/cell/beam identification.

As shown in FIG. 6, the operation of the measurement data processing apparatus 10 comprises a step S24, executed by the processing unit 18, of calculating the first visibility metric J determines a Jaccard type metric defined for the two sets S and T as a quotient of a first value representing the intersection of S and T and a second value representing the union of S and T.

Here, the Jaccard type metric may be calculated according to

$$J ( S , T ) = \frac{\vert S ⋂ T \vert}{\vert S ⋃ T \vert}$$

$$with$$

$$0 \leq J ( S , T ) \leq 1.$$

Alternatively, the Jaccard type metric may be calculated using the weights according to

$${J}^{′} ( S , T ) = \frac{{Σ}_{\{ j \text{:} {c}_{j} ∈ S ⋂ T \}} {w}_{j}}{{Σ}_{\{ k \text{:} {c}_{k} ∈ S ⋃ T \}} {w}_{k}} .$$

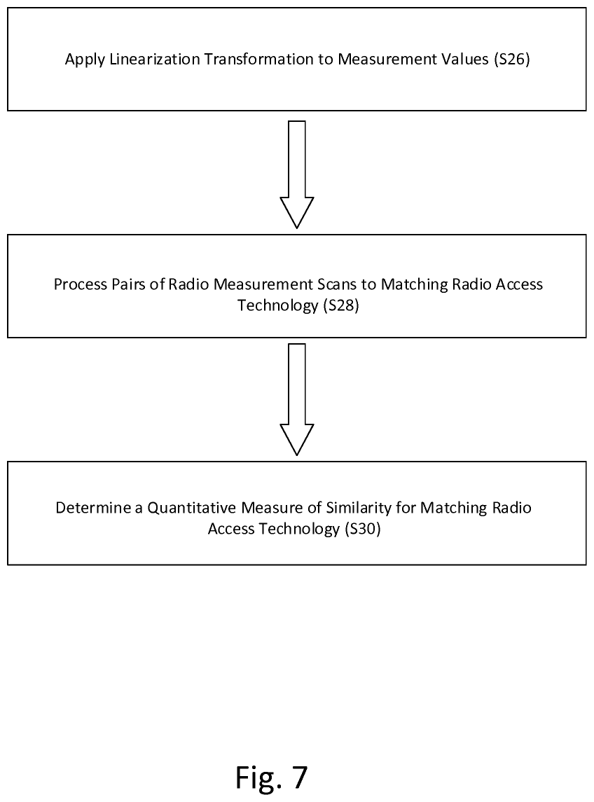

FIG. 7 shows a further flowchart of operation of the measurement data processing apparatus 10 shown in FIG. 4, in particular with respect to calculation of a second numerical metric J′ as quantitative part of the similarity metric from information carried by the measurement values of radio measurement scans.

As shown in FIG. 7, the operation of the measurement data processing apparatus 10 comprises a step S26, executed by the pre-processing unit 16, of applying a linearization transformation to measurement values of radio measurement scans assuming a propagation model with a real-valued propagation constant, γ≥2, wherein
the received power p is a nonlinear function of range r, such that p ∝ r^{-γ}; and
a pre-scaling p^{γ} brings the RSS values closer to linearity with respect to physical displacement, wherein preferably the pre-scaling value is a value of p^{-0.5}.

As shown in FIG. 7, the operation of the measurement data processing apparatus 10 comprises a step S28, executed by the pre-processing unit 16, of identifying matching radio access technology and carrier-specific sub-sets in a pair of radio measurement scans S and T for which a similarity metric is to be calculated for sub-sequent comparison of the identified sub-sets to each other.

As shown in FIG. 7, the operation of the measurement data processing apparatus 10 comprises a step S30, executed by the processing unit 18, of a second numerical metric J′ as quantitative part of the similarity metric from information carried by the measurement values of radio measurement scans based on the outcome of step S26 and step S28.

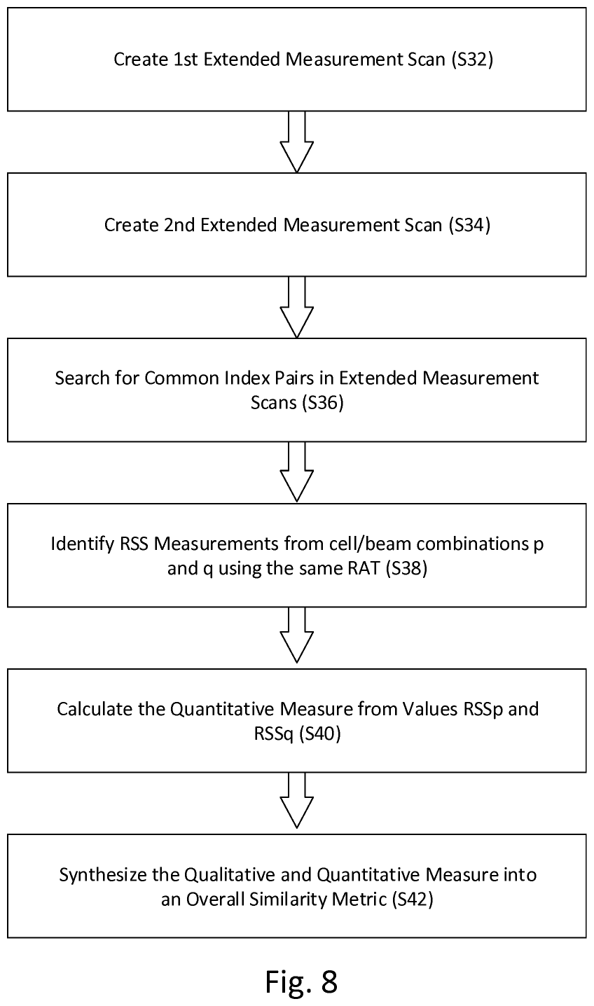

FIG. 8 shows a further flowchart of operation of the measurement data processing apparatus 10 shown in FIG. 4, in particular further details of operation with respect to steps S26 to S30 shown in FIG. 7.

As shown in FIG. 8, the operation of the measurement data processing apparatus 10 comprises steps, executed by the processing unit 18, to implement step S28 of identifying matching radio access technology and carrier-specific sub-sets shown in FIG. 7.

Here, without loss of generality it is assumed that the step S32 starts from radio measurement scans S and T comprising logarithmic radio signal strength values {sᵢ, sⱼ, sₖ, . . . } ε C as set of all cell/beam combinations and {tₗ, tₘ, tₙ, . . . } ε C, respectively.

As shown in FIG. 8, the step S28 of identifying matching radio access technology and carrier-specific sub-sets comprises
a step S32 of creating an extended radio measurement scan S′={sᵢⱼ, sᵢₖ, sⱼₖ, . . . } with sᵢⱼ=sᵢ−sⱼ, . . . , such that its members are pairwise combinations of the original members of the radio measurement scan S while ignoring pairs with are pairwise combinations of themselves and accounting for other combinations once,
a step S34 of creating an extended radio measurement scan T′={tₗₘ, tₗₙ, tₘₙ, . . . } with tₗₘ=tₖ−tₘ, . . . , such that its members are pairwise combinations of the original members of the radio measurement scan T while ignoring pairs with are pairwise combinations of themselves and accounting for other combinations once, and
a step S36 of searching in the extended radio measurement scan S′ and the extended radio measurement scan T′ for common index pairs pq ε {ij, ik, jk, lm, ln, mn, . . . } to identify matching radio access technology and carrier-specific sub-sets.

As shown in FIG. 8, the operation of the measurement data processing apparatus 10 comprises steps, executed by the processing unit 18, to implement step S16 of calculating the overall similarity metric shown in FIG. 1.

As shown in FIG. 8, the step S16 of calculating the overall similarity metric comprises
a step S38 of identifying in extended radio measurement scans S′ and T′ from different mobile terminals radio measurements RSSₚ and RSS_{q} from cell/beam combinations p and q using a same radio access technology/carrier,
a step S40 of calculating the quantitative measure from the identified different mobile terminals radio measurements RSSₚ and RSS_{q}, and
a step S42 of synthesizing the qualitative and the quantitative similarity measure into an overall similarity metric.

Preferably, the step S40 comprises calculating a pairwise ratio of the two values RSSₚ/RSS_{q} such that a mobile terminal-specific gain drops out from the quotient RSSₚ/RSS_{q} which is equivalent to a difference at log scale in dB according to ΔRSS_{pq}=RSS_{p_dBm}−RSS_{q_dBm}, more preferably a step of calculating a difference Δ_{pq}^{S′T′}=ΔRSS_{pq}^{S′}−ΔRSS_{pq}^{T′}.

Preferably, the step S40 of calculating the quantitative similarity measure drops Δ_{pq}^{S′T′} values from consideration if they are out of the range of [−lower bound in dB, upper bound in dB] to limit the number of dimensions in comparisons and increase reliability thereof, e.g., [−20 dB, 20 dB], maps values in the range of [−lower bound in dB, upper bound in dB] to a real value in [0, 1] by

$${v}_{pq}^{{S}^{′} {T}^{′}} = 1 - \frac{\vert {Δ}_{pq}^{{S}^{′} {T}^{′}} \vert}{upper bound in dB - lower bound in dB}$$

and calculates the second numerical metric J″ as quantitative part of the similarity metric according to

$${J}^{″} ( {S}^{′} , {T}^{′} ) = \frac{{Σ}_{\{ pq \text{:} {s}_{pq} ∈ {S}^{′} ⋀ {t}_{pq} ∈ T ′ \}} {v}_{pq}^{S ′ T ′}}{{ρ}_{\{ pq \text{:} {s}_{pq} ∈ S ′ ⋀ {t}_{pq} ∈ T ′ \}} 1} ɛ ( 0 , 1 ]$$

with index pairs p,q:p≠q that occur in both the extended radio measurement S′ and the extended radio measurement scan T′.

Preferably, the step S42 of synthesizing the qualitative and the quantitative similarity measure into an overall similarity metric synthesizes the first visibility metric J/J′ as qualitative part of the similarity metric and the second numerical metric J″ as quantitative part of the similarity metric into an overall similarity index M of a pair of radio measurement scans to be compared according to

M(S, T)=μᵥJ/J′(S, T)+μᵣJ″(S′, T′)

with μᵥ+μᵣ=1 and 0≤M(S,T)≤1.

Alternatively, the step S42 of synthesizing the qualitative and the quantitative similarity measure into an overall similarity metric synthesizes the first visibility metric J/J′ as qualitative part of the similarity metric and the second numerical metric J″ as quantitative part of the similarity metric into an overall similarity index M while weighting different radio access technology and carrier combinations {r₁, r₂, . . . , rₖ} and related quantitative similarity metrics {J″₁, J″₂, . . . , J″ₖ} according to

M(S, T)=μᵥJ/J′^{(S,T)}+Σᵢ₌₁^{k} μᵣᵢ J″ᵢ(S′ᵢ, T′ᵢ) ε (0, 1]

wherein the extended radio measurement scans S′ᵢ, T′ᵢ are formed from the radio access technology/carrier-specific subsets of S and T, and μᵣᵢ are radio access technology/carrier-specific weights adding up to a value of 1 and which the network operator sets in order to control the relative importance of the radio access technology/carrier-specific subsets in the similarity metric.

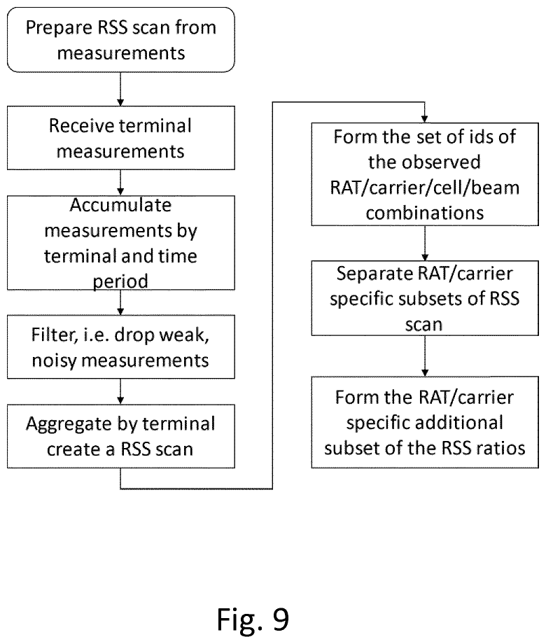

FIG. 9 shows an example of application of the present invention.

An example machine intelligence application is radio location fingerprinting, which might include a similarity metric specially developed for heterogeneous, multi-RAT, multi-carrier radio communication networks.

FIG. 9 shows the steps, which prepare the RSS data for machine intelligence applications. There are aggregation and filtering steps in the process, and the results are the RSS scans with RAT/carrier-specific subset divisions. The subsets already contain the log-scale RSS differences that are involved in the numeric similarity comparisons.

As shown in FIG. 9, the terminal measurements are collected by a central network node, which orders the incoming measurement instances by terminals and time intervals. From the viewpoint of radio location fingerprinting, a sufficiently short time interval is a period while the terminal can be considered as stationary and the period is still long enough for the terminal to perform measurements at several RATs and carriers. Preprocessing involves the collection and aggregation of all measurements that originate from a terminal in a measurement interval into a single RSS field scan. Further processing steps may form a set of the RAT/carrier/cell/beam ids seen in the interval and other RAT/carrier-specific subsets of the measured RSS values. These sets are then used as input to the various similarity metric algorithms.

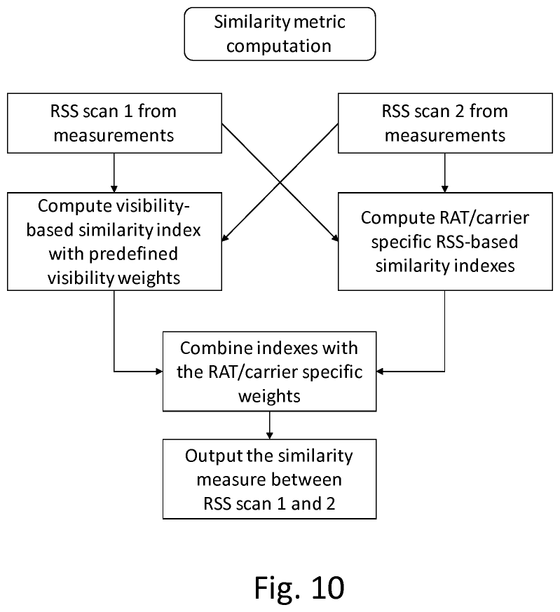

FIG. 10 shows a further example of application of the present invention.

As shown in FIG. 10, the similarity metric computation follows the data preparation. The RSS measurements performed and reported by the terminals are ordered by terminals and time first, then they arranged in the form of RSS field scans. A measurement instance includes the id of the measured RAT/carrier/cell/beam combination and the associated RSS value.

A field scan contains all RSS measurements that a terminal collects within a short interval. The similarity of such RSS measurement scans is then computed pairwise in either supervised or unsupervised machine learning applications.

As shown in FIG. 10, radio location fingerprinting algorithms should employ similarity/distance metrics that are specific to heterogeneous radio access networks. The hereby proposed algorithm combines a categorical similarity metric, which is derived from the visibility of various base station cells and beams with other numerical similarity metrics that utilize the measured RSS values themselves.

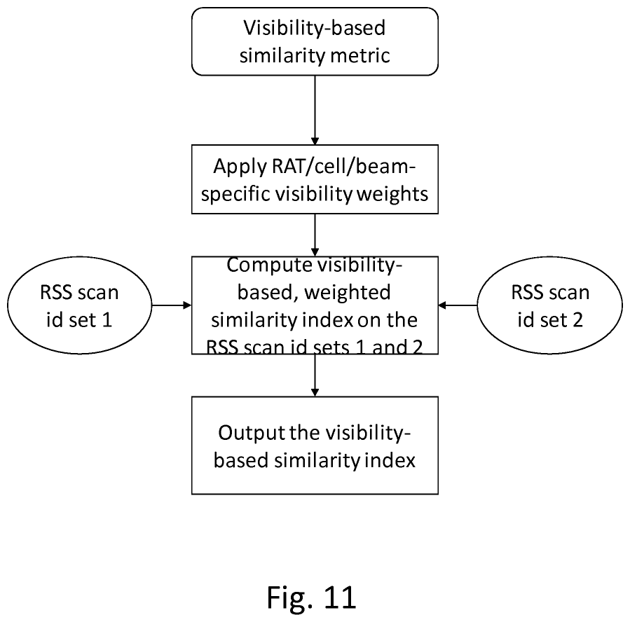

FIG. 11 shows a further example of application of the present invention, in particular the computation of the visibility-based component of the similarity metric.

As shown in FIG. 11, this algorithm compares the id sets of the two RSS field scans and computes a weighted Jaccard-type index, where the applied weights are based on expert knowledge and can be obtained in an automatic manner.

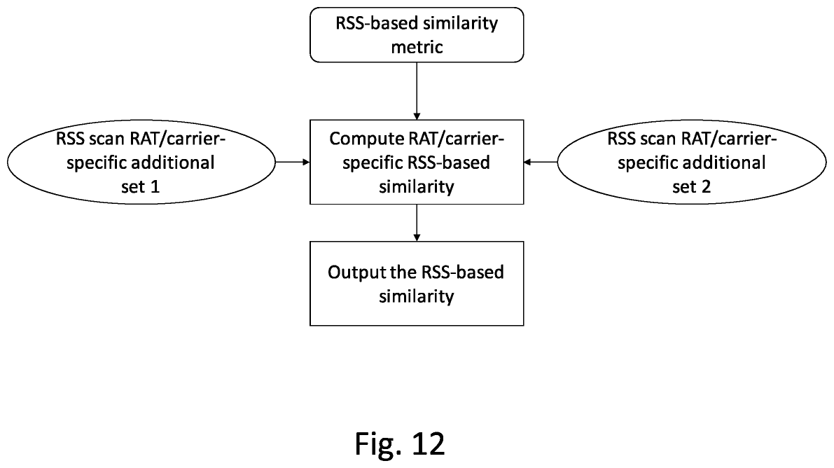

FIG. 12 shows a further example of application of the present invention in particular the computation of the RSS-based components of the similarity metric.

As shown in FIG. 12, the input to this algorithm are the RAT/carrier-specific RSS subsets of RSS field scans, and the computation is separately performed for each pair of such subsets. The comparison focuses to the RSS values that are present in both RSS scans.

Overall, the present invention as explained above addresses that machine intelligence techniques, either with supervised or non-supervised learning, need a similarity metric, or equivalently, a distance metric, which is tailored to the task.

Radio location fingerprinting is a machine intelligence technique, which is used for the localization of mobile terminals. The fingerprinting technique processes a large amount of radio measurements, e.g., RSS measurements from terminals, and it has been tested with interdisciplinary similarity metrics so far. Such metrics might be suitable for a single type of radio access technology, but a specialized, radio aware metric can perform better than the generic ones in multi-RAT, multi-carrier, beamforming heterogeneous mobile networks.

Important aspects of the present invention are as follows:
There is proposed a similarity metric to be used in radio location fingerprinting.
The metric suits multi-RAT, multi-carrier heterogeneous networks.
It can compare radio measurement mixes
   from several RATs,
   from several frequency carriers,
   from small cells and large cells,
   from sector beams and narrow beams.
The similarity metric is formulated to reflect physical distances.
The similarity metric eliminates distortions due to terminal-specific gain differences.
The similarity metric is tunable with weights so that knowledge on the concrete radio network deployment can be incorporated either manually or by an automated fashion.
The similarity metric synthesizes categorical and numerical similarities in a manner also controllable by weights based on the characteristics of the concrete radio access technologies employed in the heterogeneous network.

1-66. (canceled)

67. A method of processing measurement data delivered from a heterogeneous multi-carrier network to a measurement data processing apparatus, the method comprising:
aggregating radio measurement values reflecting radio access conditions during different measurement time intervals for at least one mobile terminal having radio access to the heterogeneous multi-carrier network into radio measurement scans;
aggregating, for every radio measurement scan, related radio measurement configurations prevailing at the time of measurement of the corresponding radio measurement values into a radio measurement configuration scan;
calculating similarity metrics for pairs of radio measurement scans to generate knowledge on radio coverage in the heterogeneous wireless network, wherein similarity metrics are customized to radio measurement conditions through reference to radio measurement configuration scans associated with pairs of radio measurement scans for which similarity metrics are calculated.

68. The method of claim 67, further comprising receiving radio measurement values reflecting radio access conditions during different measurement time intervals from at least one mobile terminal having radio access to the heterogeneous multi-carrier network periodically, upon trigger from the central network node, and/or upon changes of the radio access conditions exceeding a predetermined threshold.

69. The method of claim 67:
wherein the calculating comprises calculating a first visibility metric J as qualitative part of the similarity metric reflecting similarity of radio measurement configurations identified in two different radio measurement configuration scans;
wherein a non-empty set S of first indices represents a first radio measurement configuration scan, a non-empty set T of second indices represents a second radio measurement configuration scan, wherein the calculating the first visibility metric J determines a Jaccard type metric defined for the two sets S and T as a quotient of a first value representing the intersection of S and T and a second value representing the union of S and T;
individually weighting the index cᵢ ε C of i-th radio access technology/carrier/cell/beam identification with a weight wi ε (0, 1];
comprising calculating the weight wi ε (0, 1] according to the type of the of i-th radio access technology/carrier/cell/beam identification and related system parameters
wherein the calculating the first visibility metric J of the similarity metric calculates a real value according to
$${J}^{′} ( S , T ) = \frac{{Σ}_{\{ j \text{:} {c}_{j} ∈ S ⋂ T \}} {w}_{j}}{{Σ}_{\{ k \text{:} {c}_{k} ∈ S ⋃ T \}} {w}_{k}} .$$

70. The method of claim 67:
wherein the calculating comprises:
calculating a first visibility metric J as qualitative part of the similarity metric reflecting similarity of radio measurement configurations identified in two different radio measurement configuration scans;
calculating a second numerical metric J′ as quantitative part of the similarity metric from information carried by the measurement values of radio measurement scans;
applying a linearization transformation to measurement values of radio measurement scans assuming a propagation model with a real-valued propagation constant, γ≥2, wherein the received power p is a nonlinear function of range r, such that p ∝ r−γ; and a pre-scaling value p^{γ} brings the RSS values closer to linearity with respect to physical displacement.

71. The method of claim 70, wherein the pre-scaling value is a value of p^{-0.5}.

72. The method of claim 70:
identifying matching radio access technology and carrier-specific sub-sets in a pair of radio measurement scans S and T for which a similarity metric is to be calculated for sub-sequent comparison of the identified sub-sets to each other; wherein the radio measurement scans S and T comprise logarithmic radio signal strength values {sᵢ, sⱼ, sₖ, . . . } ε C as set of all cell/beam combinations and {tₗ, tₘ, tₙ, . . . } ε C, respectively;
wherein the identifying matching radio access technology and carrier-specific sub-sets comprises:
creating an extended radio measurement scan S′={sᵢⱼ, sᵢₖ, sⱼₖ, . . . } with sᵢⱼ=sᵢ−sⱼ, . . . , such that its members are pairwise combinations of the original members of the radio measurement scan S while ignoring pairs with are pairwise combinations of themselves and accounting for other combinations once;
creating an extended radio measurement scan T′={tₗₘ, tₗₙ, tₘₙ, . . . } with tₗₘ=tₗ−tₘ, . . . , such that its members are pairwise combinations of the original members of the radio measurement scan T while ignoring pairs with are pairwise combinations of themselves and accounting for other combinations once; and
searching, in the extended radio measurement scan S′ and the extended radio measurement scan T′, for common index pairs pq ε {iⱼ, iₖ, jₖ, lₘ, lₙ, mₙ, . . . } to identify matching radio access technology and carrier-specific sub-sets;
identifying, in extended radio measurement scans S′ and T′ from different mobile terminals, radio measurements RSSₚ and RSS_{q} from cell/beam combinations p and q using a same radio access technology/carrier; and
calculating a pairwise ratio of the two values RSSₚ/RSS_{q} such that a mobile terminal-specific gain drops out from the quotient RSSₚ/RSS_{q} which is equivalent to a difference at log scale in dB according to ΔRSS_{pq}=RSSₚ_{_{dBm}}−RSS_{q}_{_{dBm}}.

73. The method of claim 72, further comprising calculating a difference Δ_{pq}^{S′T′}=ΔRSS_{pq}^{S′}−ΔRSS_{pq}^{T′}.

74. The method of claim 73, further comprising dropping Δ_{pq}^{S′T′} values from consideration if they are out of the range of [−lower bound in dB, upper bound in dB] to limit the number of dimensions in comparisons and increase reliability thereof.

75. The method of claim 73, further comprising mapping values Δ_{pq}^{S′T′} in the range of [−lower bound in dB, upper bound in dB] to a real value in [0, 1] by
$${v}_{pq}^{{S}^{′} {T}^{′}} = 1 - \frac{\vert {Δ}_{pq}^{{S}^{′} {T}^{′}} \vert}{upper bound in dB - lower bound in dB}$$

76. The method of claim 75, wherein the lower bound is −20 dB and the upper bound is +20 dB.

77. A measurement data processing apparatus for processing of measurement data delivered from a heterogeneous multi-carrier network to a central network node, the measurement data processing apparatus comprising:
processing circuitry;
memory containing instructions executable by the processing circuitry whereby the measurement data processing apparatus is operative to:
aggregate radio measurement values reflecting radio access conditions during different measurement time intervals for at least one mobile terminal having radio access to the heterogeneous multi-carrier network into radio measurement scans;
aggregate, for every radio measurement scan, related radio measurement configurations prevailing at the time of measurement of the corresponding radio measurement values into a radio measurement configuration scan;
calculate similarity metrics for pairs of radio measurement scans to generate knowledge on radio coverage in the heterogeneous wireless network, wherein similarity metrics are customized to radio measurement conditions through reference to radio measurement configuration scans associated with pairs of radio measurement scans for which similarity metrics are calculated.

78. The measurement data processing apparatus of claim 77, wherein the instructions are such that the measurement data processing apparatus is operative to receive radio measurement values reflecting radio access conditions during different measurement time intervals from at least one mobile terminal having radio access to the heterogeneous multi-carrier network periodically, upon trigger from the central network node, and/or upon changes of the radio access conditions exceeding a predetermined threshold.

79. The measurement data processing apparatus of claim 77, wherein the instructions are such that the measurement data processing apparatus is operative to:
calculate a first visibility metric J as qualitative part of the similarity metric reflecting similarity of radio measurement configurations identified in two different radio measurement configuration scans;
calculate the first visibility metric J as Jaccard type metric defined for two sets S and T as a quotient of a first value representing the intersection of S and T and a second value representing the union of S and T; wherein S is a non-empty set of first indices representing a first radio measurement configuration scan, and T is a non-empty set of second indices representing a second radio measurement configuration scan;
individually weight the index cᵢ ε C of i-th radio access technology/carrier/cell/beam identification with a weight wi ε (0, 1];
calculate the weight wi ε (0, 1] according to the type of the of i-th radio access technology/carrier/cell/beam identification and related system parameters;
calculate the first visibility metric of the similarity metric calculates a real value according to
$${J}^{′} ( S , T ) = \frac{{Σ}_{\{ j \text{:} {c}_{j} ∈ S ⋂ T \}} {w}_{j}}{{Σ}_{\{ k \text{:} {c}_{k} ∈ S ⋃ T \}} {w}_{k}} .$$

80. The measurement data processing apparatus of claim 77, wherein the instructions are such that the measurement data processing apparatus is operative to:
calculate a first visibility metric J as qualitative part of the similarity metric reflecting similarity of radio measurement configurations identified in two different radio measurement configuration scans;
calculate a second numerical metric Yes quantitative part of the similarity metric from information carried by the measurement values of radio measurement scans;
apply a linearization transformation to measurement values of radio measurement scans assuming a propagation model with a real-valued propagation constant, γ≥2, wherein the received power p is a nonlinear function of range r, such that p ∝ r^{-γ}; and a pre-scaling value p^{γ} brings the RSS values closer to linearity with respect to physical displacement.

81. The measurement data processing apparatus of claim 80, wherein the pre-scaling value is p^{-0.5}.

82. The measurement data processing apparatus of claim 80, wherein the radio measurement scans S and T comprise logarithmic radio signal strength values {sᵢ, sⱼ, sₖ, . . . } ε C as set of all cell/beam combinations and {tₗ, tₘ, tₙ, . . . } ε C, respectively; and wherein the instructions are such that the measurement data processing apparatus is operative to:
identify matching radio access technology and carrier-specific sub-sets in a pair of radio measurement scans S and T for which a similarity metric is to be calculated for sub-sequent comparison of the identified sub-sets to each other;
create an extended radio measurement scan S′={sᵢⱼ, sᵢₖ, sⱼₖ, . . . } with sᵢⱼ=sᵢ−sⱼ, . . . , such that its members are pairwise combinations of the original members of the radio measurement scan S while ignoring pairs with are pairwise combinations of themselves and accounting for other combinations once;
create an extended radio measurement scan T′={tₗₘ, tₗₙ, tₘₙ, . . . } with tₗₘ=tₗ−tₘ, . . . , such that its members are pairwise combinations of the original members of the radio measurement scan T while ignoring pairs with are pairwise combinations of themselves and accounting for other combinations once; and
search, in the extended radio measurement scan S′ and the extended radio measurement scan T′, for common index pairs pq ε {ik, jk, lm, ln, mn, . . . } to identify matching radio access technology and carrier-specific sub-sets;
identify, in extended radio measurement scans S′ and T′ from different mobile terminals, radio measurements RSSₚ and RSS_{q} from cell/beam combinations p and q using a same radio access technology/carrier; and
calculate a pairwise ratio of the two values RSSₚ/RSS_{q} such that a mobile terminal-specific gain drops out from the quotient RSSₚ/RSS_{q} which is equivalent to a difference at log scale in dB according to ΔRSS_{pq}=RSSₚ_{_{dBm}}−RSS_{q}_{_{dBm}}.

83. The measurement data processing apparatus of claim 82, wherein the instructions are such that the measurement data processing apparatus is operative to calculate a difference Δ_{pq}^{S′T′}=ΔRSS_{pq}^{S′}−ΔRSS_{pq}^{T′}.

84. The measurement data processing apparatus of claim 83, wherein the instructions are such that the measurement data processing apparatus is operative to drop Δ_{pq}^{S′T′} values from consideration if they are out of the range of [−lower bound in dB, upper bound in dB] to limit the number of dimensions in comparisons and increase reliability thereof.

85. The measurement data processing apparatus of claim 83, wherein the instructions are such that the measurement data processing apparatus is operative to map Δ_{pq}^{S′T′} values in the range of [−lower bound in dB, upper bound in dB] to a real value in [0, 1] by
$${v}_{pq}^{{S}^{′} {T}^{′}} = 1 - \frac{\vert {Δ}_{pq}^{{S}^{′} {T}^{′}} \vert}{upper bound in dB - lower bound in dB} .$$

86. The measurement data processing apparatus of claim 85, wherein the lower bound is −20 dB and the upper bound is +20 dB.
